(19) United States
(12) Patent Application Publication
(10) Pub. No.: US 2015/0211246 A1
(43) Pub. Date: Jul. 30, 2015

(54) Rooftop Bracket or Jack System for Supporting Roofers, Roofing Supplies or Other Rooftop Loads

(71) Applicant: John Sutherland, Winnipeg (CA)

(72) Inventor: John Sutherland, Winnipeg (CA)

(21) Appl. No.: 14/167,481

(22) Filed: Jan. 29, 2014

(51) Int. Cl. E04G 21/32; F16M 13/02; E04G 5/00; E04G 5/04; E04G 3/22; E04G 3/26

(52) U.S. Cl. CPC E04G 21/3214; E04G 3/22; E04G 3/265; E04G 5/007; E04G 5/041; F16M 13/02

(57) ABSTRACT

A rooftop bracket or bundle jack system features a first unit arranged for fastening to a sloped roof near the peak, and one or more additional link units arranged to hang downward from the first unit. Each unit features supports for a step or platform for workers, supplies, tools, etc. Through this series of linked units, multiple steps/platforms are provided at different heights along the roof without needing to individually fasten each unit down. Hangers on the first unit are slidably adjustable to line up with the rafters or trusses beneath the roof sheathing for secure fastening thereto. Tie-off loops for fall-safety lines are provided on the securely fastened first unit. The step supports are movable between stowed and deployed positions, and detachable from the unit. Connection points for one or more utilities (air, water, electrical) are provided, whereby the system acts as a rooftop distribution point.

### FIELD OF THE INVENTION

The present invention relates generally to rooftop brackets or jacks used to support rooftop loads, for example on a temporary basis during shingling operations performed on sloped roofs.

### BACKGROUND OF THE INVENTION

Generally stated, roof jacks are used on pitched roofs to provide a temporary platform for standing, placing equipment and supplies, and similar. Certain roofing materials, such as cold shingles and/or tar paper, are brittle or otherwise subject to being damaged by walking on the materials, and since most new and re-roofing occurs during hot/warmer months, damage to above mentioned shingles and papers are more likely to occur because of melted bonding agents/tar within the shingles. A typical roof jack is attached by nailing the roof jack tongue to the roof (on a truss). Placement for the first roof jack is commonly done above the first row of new shingles, so as to be left in place and subsequently covered by the next row of shingles; another roof jack attached six to eight feet horizontally apart from the first roof jack and connected by typically a wood plank creates a “step” or temporary platform (two roof jacks are always required to create one step). This process is repeated in the direction of the travel path (parallel and vertical) of shingle placement. The roof jacks must be pounded up off the nails for removal, and then the nails are typically driven down to be flush with the roof, as not to disfigure or damage the covering shingles.

Prior art roof jacks or brackets and associated accessories include those disclosed in U.S. Pat. Nos. 1,201,779, 1,339,458, 1,478,682, 4,946,123, 5,113,971, 5,165,642, 6,484,986 and 6,698,702, and U.S. Patent Application Publications 2006/0059858, 2012/0118667, 2012/0267193 and 2012/0267594. U.S. Pat. No. 527,613 discloses a different style of apparatus for supporting shingles in a position hanging at an exterior wall of a building.

Nailed down roof jacks of the prior art do not provide sufficient strength for tying off of fall-prevention safety equipment thereto, and accordingly require installation and use of separate roof anchors to which such equipment can be rigged. Prior art fall-prevention tie-off solutions are shown in U.S. Pat. Nos. 5,036,949, 5,054,576, 5,850,889 and 6,805,220 and International PCT Application Publication WO06/042889.

Other prior art references relating to rooftop work safety include ladder-like devices arranged to provide safe travel atop, or up to, a sloped rooftop. Examples of rooftop ladders, roof-access ladders and ladder-attachable platforms are disclosed in U.S. Pat. Nos. 362,747, 812,620, 1,943,626, 3,792,750, 4,397,375, 4,578,016, and 4,949,810; U.S. Patent Application Publication 2007/0278037 and U.K. Patent Application GB2397611.

Despite the wealth of prior art solutions addressing various needs rooftop applications, there remains room for improvement. For example, it would be desirable to reduce or eliminate the need to install separate components for tying off safety equipment and supporting workers/supplies/tools/etc., to reduce damage to the roof materials by installation of individually fastened bundle jacks at various locations spaced around the rooftop area, to reduce heat-related damage to shingles during warm weather installation, and to improve the delivery of pneumatic or electrical power to rooftop tools and equipment.

Applicant has developed a new rooftop bracket/jack system that addresses shortcomings of the prior art in these areas.

### SUMMARY OF THE INVENTION

This summary is provided to introduce a selection of concepts in a simplified form that are further described below in the detailed description. This summary is not intended to be used to limit the scope of the claimed subject matter.

According to one aspect of the invention there is provided a rooftop bracket system comprising:

a first bracket unit comprising a first frame having opposing top end bottom ends and opposing sides joining said top and bottom ends together;

at least one hanger member attached to the first frame and extending upwardly relative to the top end of the first frame to a position thereabove for attachment to a sloped roof at a position upslope from the first frame so as to hang the first frame from the hanger member in a position lying atop the sloped roof;

at least one first connection feature carried on the first frame at the lower end thereof;

a second hanging unit comprising a second frame having opposing upper and lower ends and opposing sides joining said top and bottom ends together; and

at least one second connection feature carried on the second frame and arranged for selective engagement to the at least one first connection feature carried on the first frame to hang the second frame at a position below the bottom end of the first frame.

Preferably each first link connection feature is defined by a removable member hanging downward from a releaseable point of attachment with first frame.

Preferably each removable member comprises a hook opening in a rear side thereof that faces toward the sloped roof when the first frame is laid thereon, and each second link connection feature comprises a hook extending upward from the first frame to engage the opening in the removable member from the rear side thereof.

Preferably each removable member comprises a ledge for projecting forwardly from the first frame to support a load acting downwardly along the sloped roof against an upward facing side of the ledge, and a right angle gusset that braces said ledge and has the hook opening formed in one leg of said right angle gusset.

Preferably each removable member comprises at least one projection on a rear side thereof at a position offset to a side of the opening therein in order to abut the sloped roof to position the rear side of the removable member at a spaced distance from the sloped roof with the hook of the second frame reaching past the projection in the spaced distance between the sloped roof and the rear side of the removable member.

Preferably there is provided a dual pivot connection between each removable member and the first frame that enables movement of the removable member about two pivot axes between a storage position bound by a perimeter of the first frame in a same plane as said frame, and a useful position projecting forwardly away from the frame to extend away from the sloped roof when the first frame is laid thereon.

Preferably the dual pivot connection comprises a stem that extends into a hole in a topside of a bottom frame member of the first frame to secure the removable member thereto in a manner pivotal about a stem axis defined by said stem, and a hinge joint between said stem and the removable member to enable pivoting of the removable member about a hinge axis perpendicular to said stem axis.

Preferably the at least one first connection feature comprises a pair of first connection features and the at least one second connection feature comprises a pair of second connection features for respective engagement with said pair of first connection features.

The first and second frames may be identical.

Preferably each of the first and second frames comprises gussets provided at corners between frame members defining the top, bottom and sides of the frame.

Preferably each of the first and second frames comprises gussets provided at corners between perimeter frame members that define the top, bottom and sides of the frame.

Preferably each hanger member comprises an adjustable connection to the frame for adjustable positioning of the hanger member along the top end of the first frame.

Preferably the adjustable connection is a sliding connection by which the hanger member is slidable back and forth along the top end of the frame.

Preferably the slidable connection comprises a notched slider at a bottom end of the hanger that is slidably disposed around a top frame member of the first frame and has a notched out space in a bottom of the slider at an end thereof facing toward a respective side frame member of the first frame.

Preferably there is provided at least one tie off point carried on the first frame and arranged for selective connection of a worker safety line thereto.

Preferably the at least one tie off point is carried at the top end of the first frame.

Preferably the at least one tie off point comprises a closed loop fixed to the first frame.

Preferably the first bracket is used in combination with at least one threaded fastener, each hanger member having at least one fully encircled through-hole therein for engagement of a respective threaded fastener into a truss or rafter of the sloped roof via said fully encircled through-hole.

At least one of the first and second frames may comprises at least one hollow frame member, and at least one utility inlet and at least one utility outlet connected to said at least one hollow frame member for conveyance of a utility through a hollow interior of the at least one hollow frame member to the utility outlet from a supply line connected to the utility inlet.

In one embodiment, the hollow interior of the at least one hollow frame member is fluid tight, and at least one utility inlet comprises a hose fitting for connection of a fluid supply hose thereto.

The hose fitting comprises a pneumatic fitting for conveyance of pressurized air through the hollow interior of the first frame, or may comprise a plumbing fitting for routing of water or other liquid through the hollow interior of the first frame.

In one embodiment, at least one utility inlet and corresponding utility outlet comprise electrical cable connectors that are connected by electric wiring routed through the hollow interior of the at least one hollow frame member.

According to a second aspect of the invention, there is provided a bracket comprising:

a frame having opposing top end bottom ends and opposing sides joining said top and bottom ends together; and

at least one hanger member connected to the first frame and extending upwardly relative to the top end of the first frame to a position thereabove for attachment to a sloped roof at a position upslope from the first frame so as to hang the first frame from the hanger member in a position lying atop the sloped roof;

wherein the at least one hanger member is adjustably connected to the frame for adjustable positioning of the hanger member along the top end of the first frame.

According to a third aspect of the invention, there is provided rooftop bracket system comprising:

a frame arranged for attachment to a sloped roof in a position placing a rear face of the frame against said sloped roof; and

a removable member selectively connectable to the frame in a position in which a ledge of the removable member projects forwardly from the frame to extend away from the sloped roof when the frame is laid thereon in order to support a load acting downwardly against an upward facing side of the ledge.

According to a fourth aspect of the invention, there is provided a rooftop bracket comprising:

a frame arranged for attachment to a sloped roof in a position placing a rear face of the frame against said sloped roof; and

a ledge member connected to the frame and movable thereto between a storage position bound by a perimeter of the frame in a same plane as said frame, and a useful position projecting forwardly away from the frame to extend away from the sloped roof when the frame is laid thereon in order to support a load acting downwardly against an upward facing side of the ledge.

According to a fifth aspect of the invention, there is provided a rooftop bracket comprising a frame arranged for attachment to a sloped roof in a position placing a rear face of the frame against said sloped roof, wherein at least one of the first and second frames comprises at least one hollow frame member, and at least one utility inlet and at least one utility outlet connected to said at least one hollow frame member for conveyance of a utility commodity through a hollow interior of the at least one hollow frame member to the utility outlet from a supply line connected to the utility inlet.

### BRIEF DESCRIPTION OF THE DRAWINGS

In the accompanying drawings, which illustrate one or more exemplary embodiments of the present invention:

FIG. 1A is a front view of a series of linked together roof brackets or jacks in which an uppermost one the brackets/jacks in the series is to be fastened to a sloped roof near the peak, with the rest of the brackets/jacks hanging downward along the roof to form a series of steps or platforms for supporting workers, supplies, equipment/tools, etc. at incremental heights along the sloped roof.

FIG. 1B is a side view of the series of linked together roof brackets or jacks of FIG. 1A.

FIG. 2 is partial perspective view of a frame of the uppermost roof bracket/jack of FIG. 1, illustrating slidable connection of hangers to the frame to enable adjustment of the hanger positions according to the spacing of rafters or trusses to which the hangers are to be fastened to secure the frame in place on the roof.

FIG. 3 is partial perspective view of the frame of the uppermost roof bracket/jack of FIG. 1, illustrating connection of a fitting to a hollow frame member of the bracket/jack to enable connection of a fluid supply hose thereto, whereby the hollow frame becomes a rooftop fluid-distribution point.

FIG. 4 is partial perspective view of the frame uppermost roof bracket/jack of FIG. 1, illustrating connection of another fitting to the hollow frame of the bracket/jack, whereby one of the fittings forms a fluid inlet point and the other forms a fluid outlet point.

FIG. 5A is a partial perspective view of the frame of the uppermost roof bracket/jack of FIG. 1, illustrating a mounting hole therein for attachment of a removable step or platform support thereon.

FIG. 5B is a partial perspective view of the frame of one of the linked brackets/jacks hanging from the uppermost bracket/jack in FIG. 1, illustrating a hook thereon for connecting the linked/hanging bracket/jack to the bracket/jack above it.

FIG. 6A shows a step/platform support mounted to the bracket/jack frame of FIG. 5A via the mounting hole therein, with the step or platform support in a stowed position residing in-plane with the frame in a space bound by perimeter members thereof.

FIG. 6B shows the step/platform support of FIG. 6A having been swiveled out the stowed position about one axis of a dual pivot coupling, and being pivoted about a second axis toward a useful position for supporting a step or platform plank, as shown in FIG. 1.

FIG. 6C is a partial perspective view of the dual pivot coupling of the step/platform support in a first state corresponding to the stowed position of the step/platform support in FIG. 6A.

FIG. 6D is a perspective view of the dual pivot coupling of the step/platform support in a second state corresponding to the useful position of the step/platform support, as shown in FIG. 1B.

FIG. 7 is a partial perspective view of the frame of one of the brackets/jacks in FIG. 1 with one of two step/platform supports installed thereon and residing in the useful position.

FIG. 8 is a perspective view illustrating connection between two of the linked together brackets/jacks of FIG. 1 by engagement of the hook of one of the linked brackets/jacks into a slot-shaped opening in a rear side of one of the step/platform supports of the bracket/jack above it.

FIG. 9 is partial perspective view of the frame of the uppermost roof bracket/jack of FIG. 1, showing a different view of the sliding connection of one of the hangers to the frame to reveal a cutout space in the slider that maximizes a travel range of the slider along the frame.

FIG. 10 is a side view of the series of linked together roof brackets or jacks of FIG. 1B in use on a sloped rooftop.

### DETAILED DESCRIPTION

The following detailed description is for the purpose of illustrating embodiments of the invention only, and other embodiments are possible without deviating from the spirit and scope of the invention, which is limited only by the appended claims. The figures and elements discussed in this specification use terms meant as examples and not as limitations. Functions equivalent or comparable to those illustrated in the figures may be provided by other device(s) or structure(s).

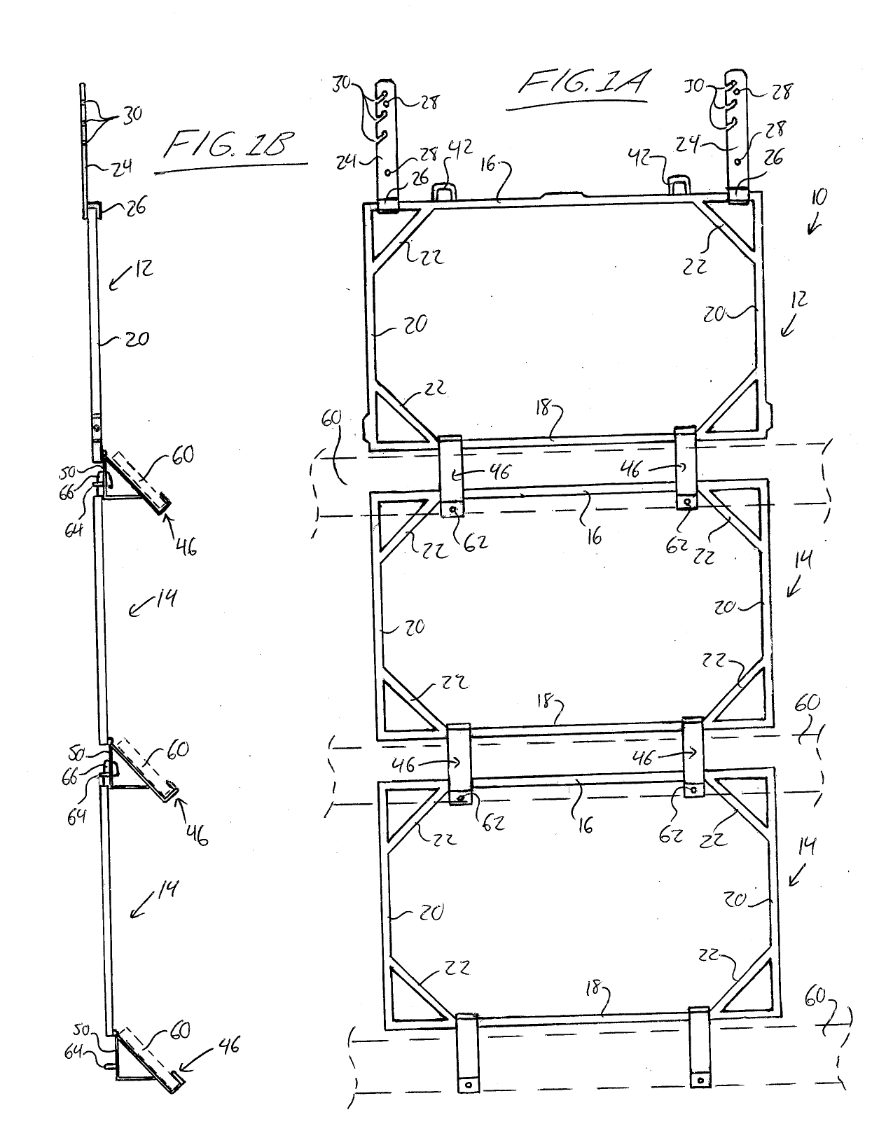

FIG. 1 illustrates a series of roof brackets or roof jacks 10 that are particularly well configured for temporary installation on a sloped rooftop for use while shingling or re-shingling the roof, but may also be used for other purposes, as outlined herein further below. One of the brackets/jacks 12 (herein also referred to as a “Bundle Jack”) is configured in a manner enabling fastening thereof to the sloped roof near the peak thereof, with the other brackets jacks 14 (herein also referred to as a “Bundle Jack Link” or “Jack Link”) are simply linked to the fastened-down bundle jack so as to hang downward therefrom along the slope of the roof. Each bundle jack and jack link is further configured to allow support of a platform thereon, for example in the form of a wooden board or plank, to allow support of supplies (e.g. shingle bundles), tools, equipment or workers thereon. By linking together a sufficient number of jack links to reach down to, or near, the eaves or fascia of the roof, the series forms a stairway arrangement in which the boards form individual steps that collectively form a safe pathway for workers needing to travel up and down the sloped roof.

With reference to FIG. 1, the bundle jack unit 12 and the jack link units 14 share a common basic frame structure, thereby simplifying manufacture of the overall system and keeping costs to minimum by duplicating parts and assembly processes used for each unit. The frame structure of the illustrated embodiment is made primarily of straight-lengths of rectangular metal tubing, for example 1-inch by 1-inch square tubing, which are used to form a top frame member 16, a parallel bottom frame member 18 spaced therefrom, and two side members 20 that join the top end bottom frame members together at the opposing ends thereof so that these four members make up a rectangular frame. A respective gusset member 22 may reinforce each corner of the rectangular frame, and for example may be provided by another length of the same metal tubing that is positioned to angle obliquely between the top or bottom frame member and one of the side frame members at a short distance inwardly from a respective corner of the rectangular frame. The frame members and gusset members thus collectively delimit an octagonal area inside a larger rectangular area bound by only the frame members.

When the frame of each bundle jack or jack link is laid flat atop the sloped roof, its top frame member 16 lies nearest the peak of the roof (thus being referred to as the ‘top’ frame member) and defines a top end of the frame that resides at a greater elevation than the bottom end of the frame defined by the opposing parallel bottom frame member 18 that lies generally parallel to the eaves or fascia of the roof. The top and bottom frame members thus lie cross-wise to the rafters or trusses that underlie the roof, with the side frame members 20 sloping upwardly along the roof in parallel with the rafters or top chords of the trusses. The frame structure of the illustrated embodiment features longer top and bottom members than side members, thus providing a frame whose length measured between the side members is greater than its width measured between the top and bottom frame members. In one embodiment, the bundle jack frame has a 1-inch thickness due to the aforementioned use of 1-inch×1-inch metal tubing, has a 38-inch length and 19-inch width, and has each gusset 22 connected at 8 inches from the respective corner in the greater length direction and 6.75 inches from the respective corner in the shorter width direction.

The bundle jack 12 features two moveable hangers 24 for easy attachment to roof truss or rafter systems. Each hanger 24 is connected to the top member 16 of the frame structure between one of the top gusset members 22 and the respective corner joint of the frame defined between the top member 16 and one of the side members 20. Each hanger slides along the length direction of the frame via a boxed slider 26 which is wrapped or enclosed around the top frame member 16 of the bundle jack frame, and holds the hanger to the bundle jack frame structure. The hangers 24 are moveable by independently sliding each hanger 24 within the available distance bound between the respective side frame member 20 and the joint between the respective gusset member 22 and the top frame member 16. The adjustable sliding of the hangers back and forth along the top member 16 allows the space between the two hangers to be adjusted to match the distance between two adjacent roof trusses or rafters so that the hangers can be fastened thereto through the roof sheathing for secure anchoring of the bundle jack.

Each hanger 24 of the illustrated embodiment is in the form of a flat generally rectangular plate welded to a short length of rectangular tubing that defines the respective box slider 26. Each hanger 24 features two unthreaded through-holes 28 to accommodate a threaded fastener (bolt or screw) that secures the bundle jack frame structure to the rafters or roof trusses. These fastener holes 28 are preferably centered on a width dimension of the hanger that lies parallel to the top frame member 16, and perpendicular to a greater length dimension of the hanger that reaches upwardly away from the top frame member 16 for connection of the hanger to the roof at a height above the bundle jack frame, which thus hangs downward from the hangers in the sloped plain of the pitched roof. In one embodiment, each hanger is 12 inches long, 1⅝ inches wide, and ⅛ inches thick, and the available sliding distance for the hanger between the side frame member 16 and the top gusset joint is 5.25 inches (resulting in an available 3.75-inch travel length for the nail/bolt holes at the center of the hanger), which together with the above example of a 38-inch bundle jack length, enables the bundle jack hangers 24 to accommodate inter-truss spans between 27.5 inches and 37.5 inches. As shown, in addition to the fastener holes 28 that are fully encircled by the surrounding plate material of the hanger 24, the hangers may feature angled nail slots 30 extending into matching sides of the two hangers to allow nail-based hanging of the bundle jack, and subsequent banging-in of the nails, in a conventional manner employed in the prior art.

As example of another potential application of the bundle jack 12, if the bundle jack is used as a wall hanger instead of as a rooftop unit, the same bundle jack hangers 24 will accommodate fastening thereof to wall studs so as to hang the frame structure vertically on a wall instead of obliquely atop a sloped roof. That is, the above described range of distance adjustment between the two hangers includes an integer multiple of conventional stud spacing, as wall studs are typically spaced apart 16-inches on center, and the hangers are adjustable to 32-inch spacing, which enables hanging of the unit on two non-adjacent wall studs in a series of three normally spaced wall studs.

Turning back to rooftop applications, the fully enclosed bolt/screw holes 28 and use of threaded fasteners (e.g. lag bolts) to connect the hangers 24 to the rafters/trusses is meant to accommodate the strength needed to allow for safety lines or other Personal Protective Equipment (PPE) or fall arrest equipment to be attached to the bundle jack 12. The nail slots 30, of which there may be three in each hanger 24 for example, can be used in a conventional manner in order to hang the bundle jack frame system on roof and allow easy removal (simple sliding the slots from of the nails for hammering thereof down to the sheathing, as opposed to removal of threaded fasteners) when fall-protection installation strength is not required. However, the nail slots 30 can also be used in conjunction with the bolt/screw fastening method to even further strengthen the attachment of the bundle jack to the roof.

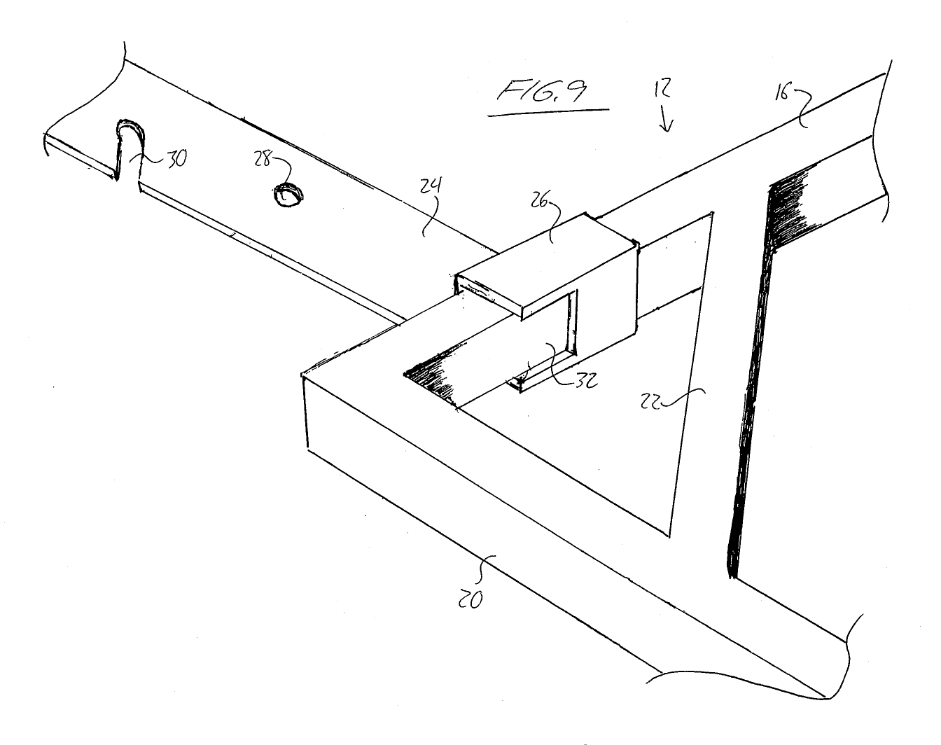

With reference to FIG. 9, the left and right hanger-sliders 26 each feature a slider-space 32 provided by a notch or cutout jutting into the end of the slider's tubular shape that faces the respective side member 20 of the bundle jack frame at the bottom wall of the slider 26 that rides along the bottom side of the top frame member 16. In one embodiment the slider-space 32 is 1-inch long, and slightly more than 1-inch wide so as to accommodate receipt of the respective side member 20 of the bundle jack frame in the space, whereby the bundle jack hangers 24 have access to the full width of the bundle jack frame. That is, the outward sliding of the hanger is not obstructed by impact of the end of the box slider 26 with the inner face of the respective side member 20 of the frame, as the cutout space 32 allows the box slider to continue past this point until the end of the cutout 32 reaches the side member of the frame, whereby a hanger 24 whose width doesn't exceed the axial length of the tubular slider 26 can still reach a position past the inner face of the side member 20 in order to situate the fastener holes 28 at the very outer edges of the side frame members 20.

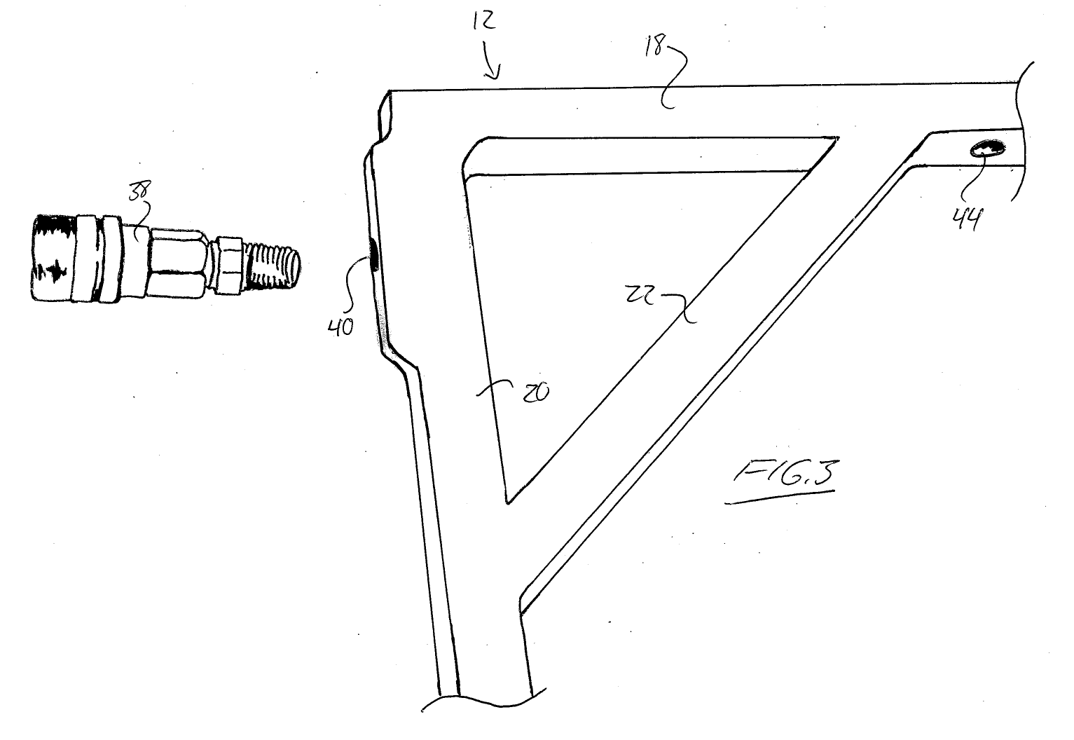

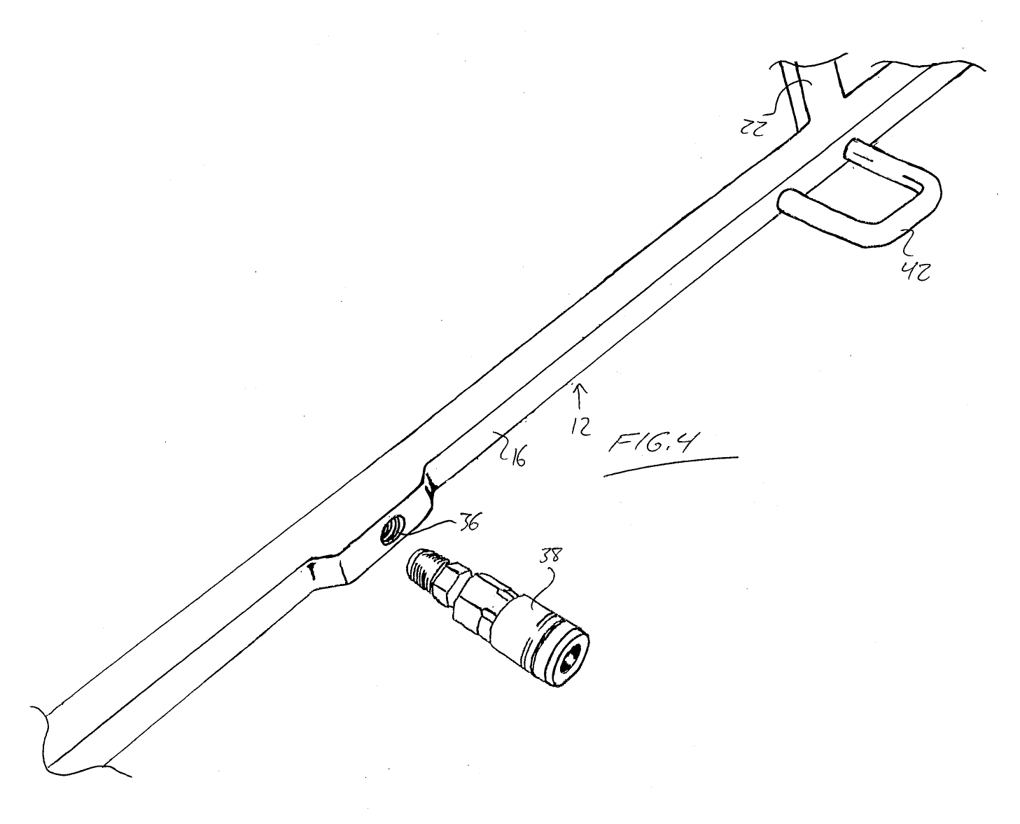

With reference to FIG. 4, at an intermediate location along the top frame member 16 between the hangers 24 is a threaded hole or port 36 that communicates with a hollow interior of this tubular frame member 14, for example at a central position therealong. The female threading of the hole 36 accepts the male threading of a pneumatic hose fitting 38 meant to accommodate the attachment of an air-hose coupling so that the air hose coupled to this fitting 38 can connect to external air-powered pneumatic equipment, such as roofing nail guns. Located on either the left or right side frame member 20, or both side members 20, of the bundle jack frame is another threaded hole or port 40 that communicates with the hollow interior of the side frame member 20, as best shown in FIG. 3 near the corner between one of the frame's side members 20 and the frame's bottom member 18. This additional hole or port 40 accommodates the attachment of another pneumatic fitting 38 for selective connection thereto of an air-hose coupling of an air hose connected to an external pressurized-air source, such as an air compressor. The side frame members 20 are fitted and fixed together at their corners, for example by welding, in a such a manner as to communicate their hollow interiors with one another, while providing an air-tight sealing off of these hollow interiors at all points other than the fitting-accommodating holes or ports 36, 40. The bottom frame member 18 may likewise have its hollow interior in communication with the side members 20, whereby the entire rectangular frame is filled with air when one of the ports 36, 40 is coupled to a pressurized air source.

With the presence of ports 40 on both side members of the frame of the illustrated embodiment, a user can select which of these two ports to connect the air source to, for example depending on the particular placement of bundle jack/link system on the roof and the air compressor being connected thereto. In addition, with at least three total ports, the frame can serve as a manifold for connection of multiple air-tools thereto, with one of the two side ports 40 serving as an inlet port connected to the air compressor, and the other side port serving as an outlet port that compliments the topside port 36 to enable connection of multiple tools. In other words, any one of the ports can serve as either an air inlet or air outlet. For example, if a particular job site is best suited by positioning of the air compressor on the ground one a side of the roof peak opposite that where the bundle jack is needed, for example as may be dictated by the availability of a nearby power source for the air compressor, then the air hose from the compressor can be run up one side of the roof and over the peak and connected to the nearest port 36 at the top of the bundle jack.

As an alternative to pneumatic fittings 38, plumbing fittings may be connected to the ports of the hollow frame members for connection of a water supply hose to one port, and a water distribution hose to another port. For example, the coupling of a water hose from an exterior house water tap and connection of one or more water hoses from the bundle jack frame to a rooftop sprinkler/mist system sets up a water-based cooling system for casting water over the roof area to protect shingles from being damaged by foot travel on days when the temperature and heat generated from the sun would otherwise melt the tar/bonding agent that retains the topside granular material on the substrate of the shingles. To ensure leak-free integrity of the water-distributing bundle jack, it may employ one or more internal hoses encased within the hollow interior space of the frame to provide one or more water conveying conduits between two or more ports. Alternatively, it is contemplated that the water may directly fill the hollow interior space of the frame members.

It will be appreciated that the bundle jack frame may have as few as two ports, and still serve as a rooftop water or air distribution point fed by a separate air or water source, which may be situated at ground level. The ports need not necessarily communicate with the interior spaces of multiple frame members. For example one embodiment may have an inlet port and one or more outlet ports all within a same frame member, whose hollow interior is simply plugged or sealed at its opposing ends during manufacture prior to attachment of the other frame members, whereby the need to provide air/water tight connections between frame members is no longer required.

In another embodiment, instead of attachment of pneumatic or plumbing ports communicating with internal air/water conveyance passages (whether provided directly by the interior of the frame, or by internal air/water hoses/tubing), the frame may feature two or more electrical connectors mounted on one or more of the frame members and wired together via the hollow interior(s) of the one or more frame members. In one such embodiment, a shrouded male electrical connector serves as power source connection to which the female end of an extension cord from a generator or mains electrical outlet can be connected, and a female electrical connector (i.e. socket) internally wired to the shrouded male connector through the hollow bundle jack frame would serve as an outlet to which electric power tools or other electrical equipment may be connected to receive power from the generator or mains outlet. Any number of different electrical devices may be operated in such a manner, including electric drills, saws, lights, battery chargers, radios, etc.

Accordingly, the bundle jack 12 can serve as a rooftop distribution point for air, water or electricity, which are collectively referred to herein as “utilities”. From the forgoing description, it will therefore be appreciated that the term “utilities” is not being used to specifically denote a commodity being provided from a centralized source delivering that commodity to the general public (i.e. a ‘public utility’), particularly since public distribution of pressurized air is not in place and, as outlined above, a generator may be used as an alternative to mains power to provide electricity to bundle jack. Likewise, although urban homes will typically be connected to a public water utility, rural homes typically employ a local well-water source which from which a water-distributing bundle jack would obtain its pressurized water supply pumped from the well, for example via an outside tap of the household water distribution system via which garden hoses and the like are typically coupled.

In some embodiments, the bundle jack may be equipped to handle connection of more than one utility, for example using air/water tight separation between the interiors of the different frame members to provide air/water/electrical service at different frame members of the bundle jack. While the illustrated embodiment of FIG. 1 provides utility service at only the bundle jack 12 at the top of the linked-together series, whereby any hoses/cables being connected are located near the peak of the roof to avoid tripping hazards that may be caused by connection to jack links 14 lower down the series, other embodiments may additionally or alternatively provide utility distribution at one or more of the jack links 14.

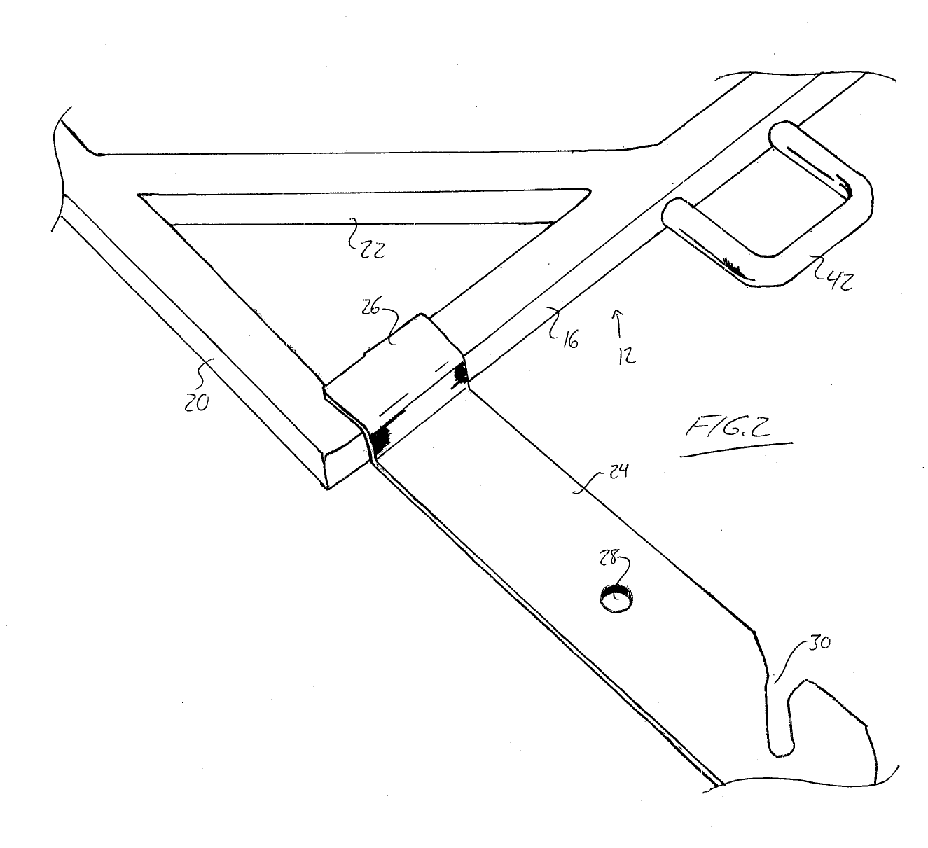

As best shown in FIGS. 1A, 2 and 4, on the top member 16 of the bundle jack frame, located between the two hangers 24, are two harness/safety line/fall-arrest equipment connection Loops 42, which for example may be defined by fixing (e.g. welding) a generally U-shaped metal rod to the topside of the frame member 16 at the two free ends of the rod, whereby the U-shaped metal rod cooperates with the span of the top member 16 between the parallel legs of the rod to form a closed loop to which a safety line or like can be tied off with a suitable connector that conforms with prescribed safety standards. As discussed above, with the bundle jack 12 firmly anchored near the roof peak to two underlying rafters or trusses via threaded fasteners engaged through the two hangers 24, it provides suitable strength to act as an anchor or tie-off point for fall prevention equipment, unlike prior art nail-down roof jacks. In one embodiment, the U-shaped connection 42 is 2.5-inches wide and 2 inches long, featuring ⅜-inch thick round steel.

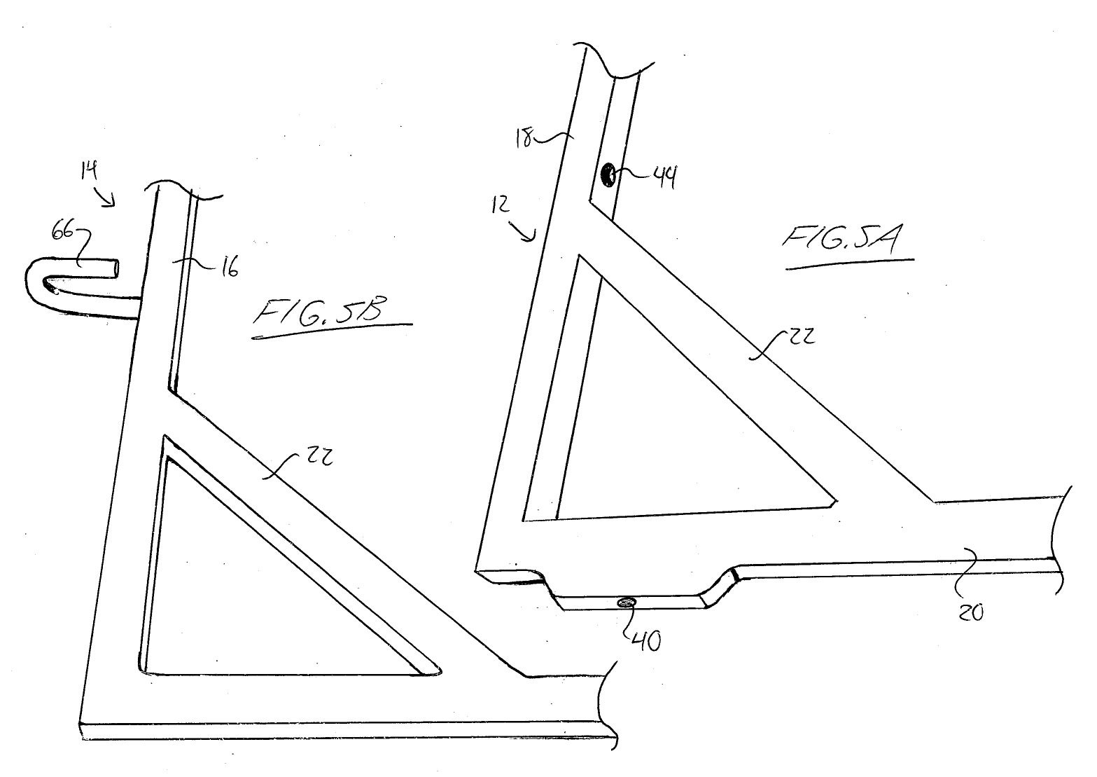

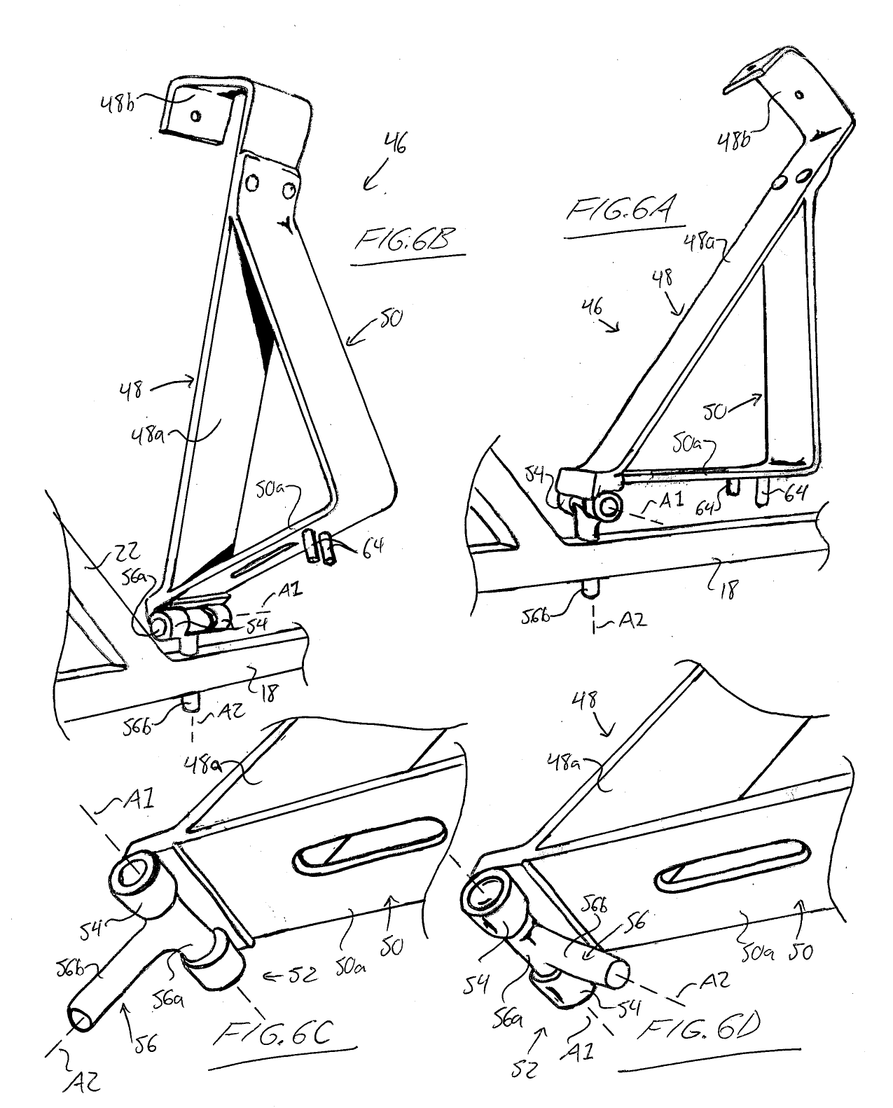

The bottom frame member 18 of the frame of the bundle jack and each bundle jack link has two holes 44 extending therethrough, from the topside thereof that faces the opposing top member 16 and onward through the opposing underside of the bottom member 18. Each hole 44 resides near a respective one of the gusset members 22 at the central portion of the bottom frame member 18 that spans between the two bottom gusset members 22. One of these holes 44 is visible in FIGS. 3 and 5A. In one embodiment, these holes 44 are spaced 23⅞ inches apart along the bottom frame member 18, and 6⅞ inches from each corner of the frame. Each hole 44 accommodates placement of one removable bundle jack step support 46 on the frame by receipt of a coupling portion of the support 46 in the hole 44. With reference to FIG. 6, each step support 46 features a generally J-shaped ledge member 48 defined by a relatively narrow strip-like piece of metal plate. A linear portion 48a of the J-shaped ledge member 48 has a right-angle gusset member 50 fixed to the rear side that faces away from the direction-reversing or hooked end portion 48b where the J-shaped ledge member features two ninety degree bends in order to turn back along the main stem or linear portion 48a of the J-shape for a short partial distance therealong

At the corner of the step support 46 at which the right angle gusset 50 is rigidly attached to the free end of linear stem 48a the J-shaped ledge member 48 opposite the hooked end 48b of the J-shaped member 48, a dual axis pivot coupler 52 is attached at this corner in order to reside on the rear side of the gusset 50 that faces away from the J-shaped ledge member 46. A base of the coupler 52 is welded to this rear side of the step support 46 and features a pair of cylindrical collars 54 axially spaced apart from one another in the width direction of the step support 46. A cylindrical head 56a of T-bolt 56 has its opposing ends rotatably received within the cylindrical collars 54, whereby the T-bolt 56 is rotatable about the axis A1 of its cylindrical head 56a, which coincides with aligned axes of the cylindrical collars 54. The stem shaft 56b of the T-bolt 56 projects perpendicularly from the cylindrical head 56a of the T-bolt at a location between the two collars 54. To connect the step support 46 to the frame of the bundle jack 12 or bundle jack link 14, the stem shaft 56b of the T-bolt 56 is inserted into one of the holes 44 in the bottom frame member 18 from the topside thereof. When so connected, the step support 46 is pivotal relative to the frame about two distinct axes A1, A2 that lie perpendicular to one another and are respectively defined by the head and stem shaft of the T-bolt. In one embodiment, The “T”-bolt is made of round steel bar and measures 2 inches long across the top bar or head 56a and 0.25 inches thick; with the lower stem shaft 56b part of the “T”-bolt measuring 1.75 inches long and 0.25 inches thick.

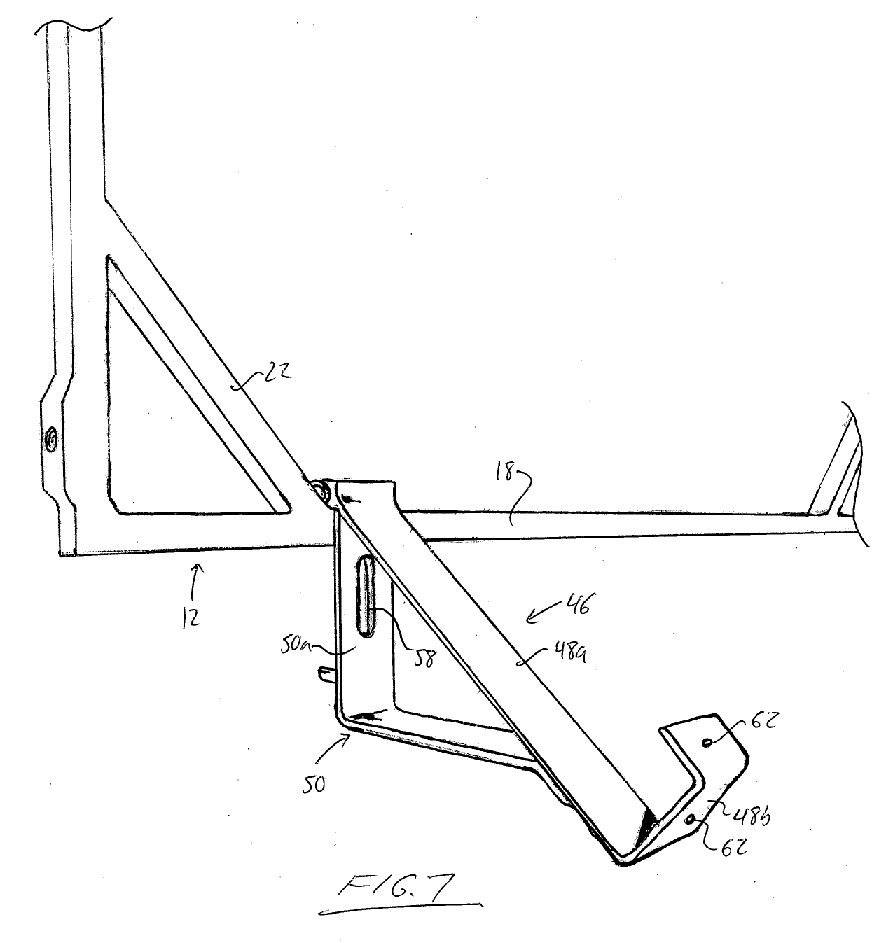

The dual axis T-bolt coupler 52 thus allows for the step support 46 to be raised when not in use, and then be swiveled and folded into the bundle jack frame area when in this raised condition, while also allowing the step support 46 to be lowered to a seated position on the front of a top frame member 16 of a an attached bundle back link 14, if attached. With reference to FIGS. 6A and 6B, the step support 46 can pivot or swivel about the stem axis A2 that is defined by the rotatable receipt of T-bolt stem 56b in the through hole 44 of the bottom frame member 18. The step support 46 is pivotable about this axis A2 between a storage position (FIG. 6A) lying in-plane with the frame of the bundle jack or bundle jack/link within the octagonal area bound by the frame, and an intermediate position (FIG. 6B) lying in a plane perpendicular to that of the frame. From the intermediate position of FIG. 6B, the step support 46 can then be pivoted downward about a hinge axis A1 that is defined by the rotable mating of the T-bolt head 56a with the cylindrical collars 54, until the first leg 50a of the gusset 50 that extends from the T-bolt coupler 52 comes into seated contact on the front side of the frame's bottom member 18, thus marking a deployed position of the step support 46 shown in FIG. 7. In this deployed position, the step support 46 continues to reside in a plane perpendicular to the frame, but the first gusset leg 50a now lies parallel to the sloped roof against which the rear face of the frame is seated, and the linear stem 48a of the J-shaped ledge-member 48 now extends forwardly outward from the plane in which the frame is seated on the roof at an angle extending obliquely downward from the frame.

The engagement of the T-bolt stem 56b downward into a corresponding upwardly-opening hole 44 in the bottom frame member 18 not only contributes to a movable connection by which the step support can be manipulated between different positions, but also provides a simple connection requiring no separate fasteners or tools to secure the step support 46 to the frame. The downward slope of the roof, and matching slope of the frame laid thereatop, gravitationally biases the T-bolt stem in its engaged position matingly received within the respective hole 44 in the frame.

The rear side or back section of the step support 46 also has a slot-shaped hook opening 58 extending through the first leg 50a of the step support gusset 50 and lying longitudinally thereof to accommodate the connection of a bundle jack link 14 to the bottom of a bundle jack 12 or a bundle jack link 14 to which the step support 46 is removably attached via its T-bolt coupler 52. In one embodiment, the hook slot 58 measures 0.5 inches wide; 1⅞ inches long; and ⅛ inches deep (as defined by the thickness of steel plate used for each step support 46), and is located 1.75 inches from the coupler-equipped top end of the deployed step support 46 and 2-inches from the bottom end of the first gusset leg 50a at the corner between the two right-angle legs of the gusset 50. The bent, slotted, gusset-defining member 50 provides strength to maintain the shape and position of the deployed ledge member 48 and provides a stop that defines this deployed position through contact of the gusset member 50 with the front face of the bottom frame member 18 of the frame to which the step support 46 is coupled by its T-bolt and contact with the front face of the top frame member 16 of any additional jack/link frame hung below it.

In one embodiment, the J-shaped ledge member 46 may feature a linear stem 48a measuring 10.25 inches long and 1.75 inches wide; and a hooked end 48b in which a first leg bent at a 90-degrees to the stem 48a extends 2.5 inches therefrom, and a second leg lying at 90-degrees to the first leg extends 1⅛ inches therefrom back along the stem. This hooked end 48a with its two ninety degree bends accommodates receipt of the thickness-defining edge of a wooden plank having a thickness of up to 2.25 inches, whereby the plank 60 lies flat atop the front face of the ledge member's linear stem 48a and is blocked from sliding off the ledge member 48 by the hooked or bent end 48b thereof.

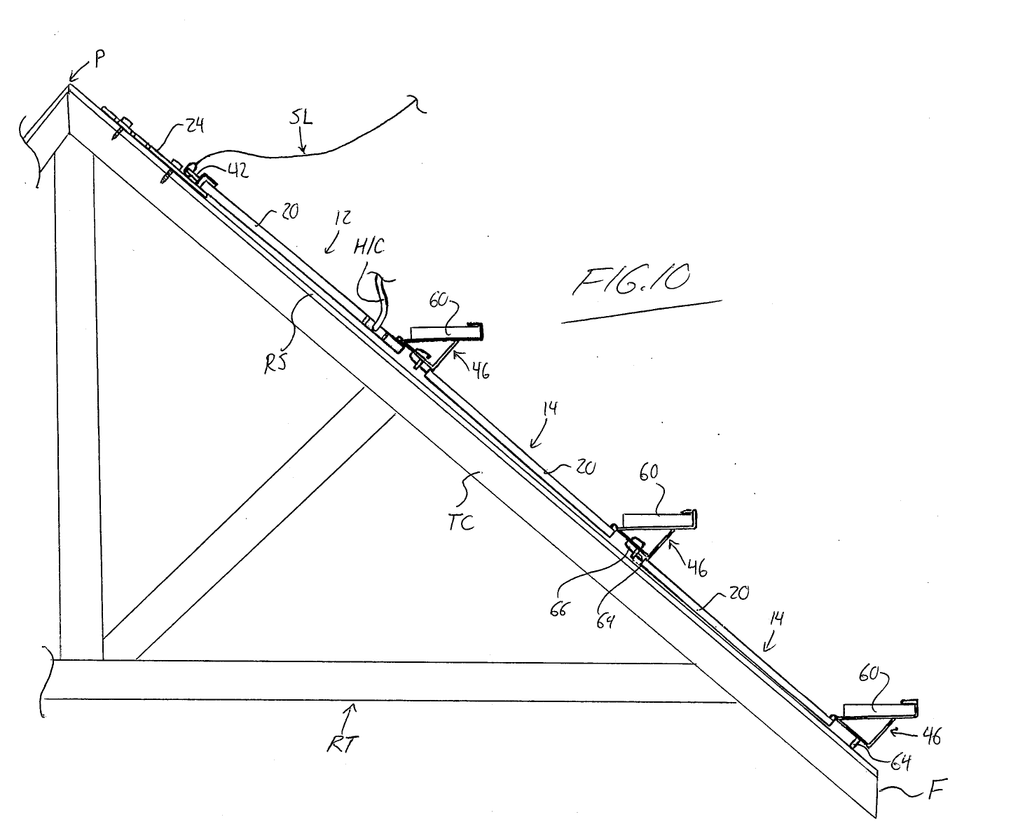

FIG. 1 shows receipt of such a plank 60 in broken lines at the pair of deployed step supports 46 on each bundle jack 12 and bundle jack link 14, where the elongated direction of the plank lies parallel to the top and bottom frame members 16, 18 and may extend from the illustrated bundle jack and jack link series 10 to another aligned series installed on the same sloped roof section at a distance spaced horizontally from the first series. Alternatively, shorter planks having similar length to the bundle jack and jack/links may be used. Either way, the width of the plank lies at oblique angle relative to the sloped roof on which the frames are seated in order to provide a generally horizontal step or support platform on which workers may stand during a roofing operation, on which bundles of shingles or other supplies may be seated, and on which tools or other equipment may be temporarily placed or stationed. By suspending bundle jack/links 14 from the top bundle jack 12, the steps of platforms create an effectively stairway or walkway for safe travelling of workers up and down the sloped roof, as best illustrated by FIG. 10.

The two bent sections of the hooked end 48b of the ledge member 48 each feature a nail-through hole 62 in order to secure the wood plank 60 securely to the bundle jack step support 46. The rear side of the first gusset leg 50a has two step-rests 64 projecting perpendicularly therefrom at positions offset to opposing sides of the centrally-located slot-shaped hook opening 58 at a location situated between the slot 58 and the bent lower end of the first gusset leg 50a that attaches to the second leg of the right angle gusset 50. The step rests 64 may be provided in the form of cylindrical prongs/pegs/posts, flat plate-shaped members, or other configurations, and in one embodiment measure 1-inch long and 0.25-inches wide. These step rests 64 form added roof-contacting supports for weight distribution of any load on the plank 60 at a point between two adjacent frames in the bundle jack and link series. In addition, the step rest projections 64 also serve as support for a step board 60 used at the bottom of a single bundle jack 12 that has no jack links 14 suspended below it, or for a step at the bottom of the bundle back/link series 10 (FIG. 1). At either such location, there is no top frame member of a next jack link 14 for the lower portion of the first gusset leg 50a to lie on, and so the prongs 64 instead contact the roof in order to maintain the lower portion of the gusset leg 50a in a spaced and parallel relation to the roof. Prongs may instead be metal plates (for example, 1×1×0.25 inches thick, and for example may be used to fasten a thin board under the rear of the step supports of the lowermost link in the series to fill the space between the rear of the step support and roof to better support the same.

Each bundle jack link 14 is meant to create an additional storage/step section below the initial bundle jack 12 or below the bottom of other bundle jack links. Each link 14 has two hooks 66 attached to its top frame member 16 to extend upward therefrom in an orientation placing the jaw or opening of the hook in a forwardly-opening orientation facing away from the underlying roof on which the frame is laid. The hooks 66 are spaced apart along the top frame member 16 by a distance matching the spacing apart of the holes 44 in the lower frame member 18. In one embodiment, the two hooks are located 23⅞ inches apart from each other, and each hook is spaced 6⅞ inches inward from the top corners of the link 14.

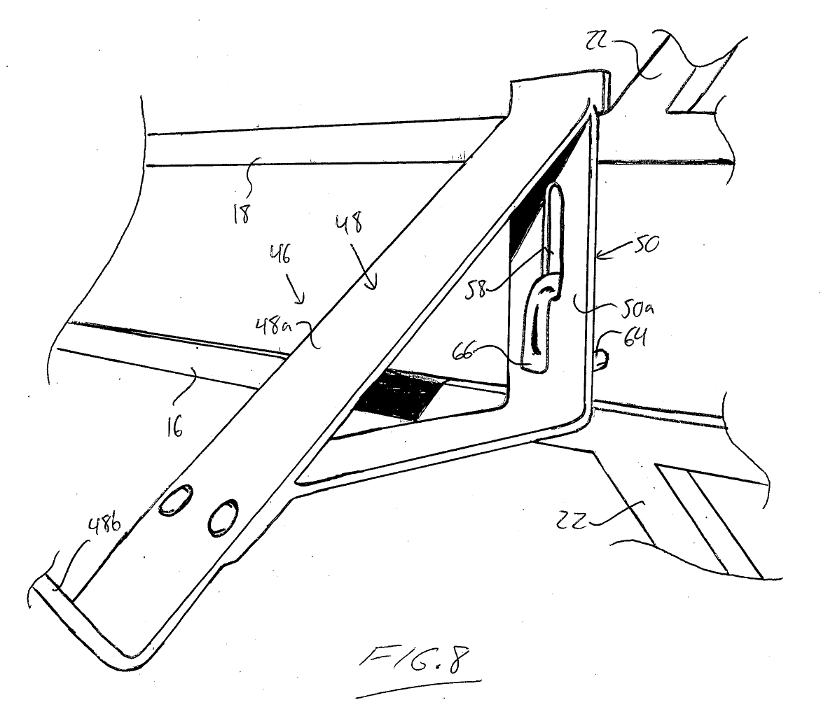

As shown in FIGS. 1B and 8, each hook 66 on the link 14 is hooked through the hook-opening 58 in a respective one of the step supports 46 of the bundle jack 12 or link 14 above it. The hook 66 passes through the hook opening 58 from the rear side of the first gusset leg 50a of that step support 46, whereby this newly added link 14 is hung from the jack or link above it in a position suspended therebeneath along the downward slope of the roof. The spacing maintained between the first gusset leg 50a and the roof by the seated position of the gusset 50 on the front face of the frame to which it is attached and the seated position of the stop rests 64 on the roof allows the link 14 to be hooked up to the gusset 50 in the space between the roof and the gusset via the spacing between the two step rests 64.

FIG. 10 shows the bundle jack 12 and bundle jack links 14 of FIG. 1 in use of a sloped roof, where each hanger 24 of bundle jack 12 is fastened to the top chord TC of a respective roof truss RT through the roof sheathing RS near the peak of the roof P. The jack links 14 hang downward from the fastened-down bundle jack 12 toward the fascia F, and the wooden plank 60 carried on the two step supports 46 of each unit define a series of horizontal steps or platforms running up the sloped roof toward the peak. Safety line SL is tied off to the loops 42 of the bundle jack 12, and an air/water hose or electrical cable H/C is connected to the bundle jack for running of tools or a water cooling system. The relative lengths of the two right angle legs of each step support gusset 50 may differ among different models of step supports 46 that are configured for different standard roof pitches, whereby use of the prescribed model of step support 46 on a roof of the corresponding pitch will ensure a horizontal orientation of the linear leg 48a of the J-shaped member 48 that creates the upward facing ledge surface on which the wooden plank 60 is installed to form a horizontal step or platform.

In summary of the disclosed invention, the bundle jack/link roofing system replaces or compliments the need of using a typical roof jack for shingling applications, but is not limited to be used for such purposes. The bundle jack 12 and links 14 reduces the need for multiple separately-anchored roof jacks in a vertical direction along the sloped roof. Other possible applications include use by rural residents as wall or roof storage for fishing nets; gardening implements and plants; fishing and hunting storage platforms or hangers for animal carcasses; small boat storage such as kayaks and canoes; or common residential winter/summer yard-care tools; etc.

Generally stated, the disclosed invention reduces or eliminates damage to roof materials (by enabling support of multiple units without requiring individual fastening-down of each individual unit), protects and provides safety aspect for rooftop workers, equipment and the temporary safe storage of equipment and materials. The disclosed invention also reduces or eliminates danger of falling, slipping, and sliding of workers, materials, and equipment from roof deck to lower levels or ground.

When performing the task of shingling a home, whether it be new home construction, or a removal and replacement of existing shingles on residential houses or commercial establishments using shingles for weather protection, it is necessary for a roofer to access the roof peak to establish a point of worker travel, safety-line implementation (if there is a safe means/object/point of safety-line placement for harness/PPE/fall-arrest equipment), and safe placement of roofing material/equipment.

As most residential roof configurations do not allow for the placement of safety line securement, have a weight limitation allowable per line, or have a ‘number of person per line’ limit, the bundle jack/jack link System compliments current safety devices such as roof jacks, and provides for easy installation of safety-lines; eliminates the danger of attaching safety-ropes/lines to dangerously precarious objects such as chimneys, plumbing stacks, or over-hanging tree limbs and branches; and allows for the safe storage of material and equipment; and gives workers a safe and accommodating travel path up/down/across roof work area.

From the forgoing description, it will be appreciated that the hook openings 58 on the selectively attachable/detachable step supports 46 of the illustrated embodiment provide connection features carried on the bundle jack 12 or bundle jack link 14 by which an additional jack link 14 can be hung therebelow via the corresponding hook-defined connection features 66 of the additional jack link 14. It will be appreciated that the advantage of a series of step or platform supporting brackets securely anchored to the rooftop by fastening-down of only the uppermost bracket in the series may also be accomplished by embodiments in which the connection features for hanging a next bracket of the series are found directly in the frame of the bracket or in a permanently attached fixture thereon rather than in a removable step or platform support 46. Similarly, the advantage of step/platform supports 46 movable between stowed and deployed positions on the frame may be accomplished regardless of whether the supports 46 are removable from the frame or permanently attached thereto. However, the use of removable supports reduces the weight and bulk of the frame, thus potentially easing the process of delivering each frame to a rooftop location. Keeping the supports separate 46 until the frame is in place also avoids potential injury by inadvertent swinging of the movable supports 46 about their hinge and stem axes without having to add some sort of preventative locking mechanism to secure the supports in the stowed position within the frame space.

It will be appreciated that other advantageous features of the disclosed invention may likewise be employed independently of, or in various combinations with, the other unique features, including use of one or more hollow frame members through which a utility is routed to create a rooftop utility distribution point, and sliding or other positional adjustment of hanger members to accommodate differences in rafter/truss positions relative to one another or relative to the frame. It will also be appreciated that any dimensions disclosed above are presented as examples only, and may be varied.

The disclosed embodiments provide the foregoing unique features and resulting advantages or benefits in a system of minimal complexity, in which the basic components can be easily summarized as follows:

### Bundle Jack Frame:

Two hangers 24 (for example, each having three angled slots 30 for nails; two bolt/screw holes 28; and one slider 26 with an open space 32 to accommodate outer edge 20 of frame)

One or more safety loops 42

Two or more threaded holes 36, 40 for air/water hose fittings (for example, one hole 36 accommodating incoming air/water; two holes 40 accommodating outgoing air/water)

Two holes/tubes 44 each accommodating one removable step support 46

Four Gussets 22

### Bundle Jack Link Frame:

Two Hooks 66 (each connecting to the back/underside of one removable step support 46)

Two holes/tubes (each accommodating one removable step support 46)

Four gussets 22

### Bundle Jack/Link Step Support:

Each step support 46 has one gusset 50; two prongs/metal plates 64; one hook slot 58; two nail holes 62 to secure a wood plank 60; one “T”-Bolt coupler (swivel) 52.

Since various modifications can be made in my invention as herein above described, it is intended that all matter contained in the accompanying specification shall be interpreted as illustrative only and not in a limiting sense.

1. A rooftop bracket system comprising:
a first bracket unit comprising a first frame having opposing top end bottom ends and opposing sides joining said top and bottom ends together;
at least one hanger member attached to the first frame and extending upwardly relative to the top end of the first frame to a position thereabove for attachment to a sloped roof at a position upslope from the first frame so as to hang the first frame from the hanger member in a position lying atop the sloped roof;
at least one first connection feature carried on the first frame at the lower end thereof;
a second hanging unit comprising a second frame having opposing upper and lower ends and opposing sides joining said top and bottom ends together; and
at least one second connection feature carried on the second frame and arranged for selective engagement to the at least one first connection feature carried on the first frame to hang the second frame at a position below the bottom end of the first frame.

2. The system of claim 1 wherein each first link connection feature is defined by a removable member hanging downward from a releaseable point of attachment with first frame.

3. The system of claim 1 wherein each removable member comprises a hook opening in a rear side thereof that faces toward the sloped roof when the first frame is laid thereon, and each second link connection feature comprises a hook extending upward from the first frame to engage the opening in the removable member from the rear side thereof.

4. The system of claim 2 wherein each removable member comprises a ledge for projecting forwardly from the first frame to support a load acting downwardly along the sloped roof against an upward facing side of the ledge, and a right angle gusset that braces said ledge and has the hook opening formed in one leg of said right angle gusset.

5. The system of claim 3 wherein each removable member comprises at least one projection on a rear side thereof at a position offset to a side of the opening therein in order to abut the sloped roof to position the rear side of the removable member at a spaced distance from the sloped roof with the hook of the second frame reaching past the projection in the spaced distance between the sloped roof and the rear side of the removable member.

6. The system of claim 2 comprising a dual pivot connection between each removable member and the first frame that enables movement of the removable member about two pivot axes between a storage position bound by a perimeter of the first frame in a same plane as said frame, and a useful position projecting forwardly away from the frame to extend away from the sloped roof when the first frame is laid thereon.

7. The system of claim 6 wherein the dual pivot connection comprises a stem that extends into a hole in a topside of a bottom frame member of the first frame to secure the removable member thereto in a manner pivotal about a stem axis defined by said stem, and a hinge joint between said stem and the removable member to enable pivoting of the removable member about a hinge axis perpendicular to said stem axis.

8. The system of claim 1 wherein the at least one first connection feature comprises a pair of first connection features and the at least one second connection feature comprises a pair of second connection features for respective engagement with said pair of first connection features.

9. The system of claim 1 wherein the first and second frames are identical.

10. The system of claim 1 wherein each of the first and second frames comprises gussets provided at corners between frame members defining the top, bottom and sides of the frame.

11. The system of claim 1 wherein each of the first and second frames comprises gussets provided at corners between perimeter frame members that define the top, bottom and sides of the frame.

12. The system of claim 1 wherein each hanger member comprises an adjustable connection to the frame for adjustable positioning of the hanger member along the top end of the first frame.

13. The system of claim 12 wherein the adjustable connection is a sliding connection by which the hanger member is slidable back and forth along the top end of the frame.

14. The system of claim 13 wherein the slidable connection comprises a notched slider at a bottom end of the hanger that is slidably disposed around a top frame member of the first frame and has a notched out space in a bottom of the slider at an end thereof facing toward a respective side frame member of the first frame.

15. The system of any claim 1 comprising at least one tie off point carried on the first frame and arranged for selective connection of a worker safety line thereto.

16. The system of claim 15 wherein the at least one tie off point is carried at the top end of the first frame.

17. The system of claim 1 wherein the at least one tie off point comprises a closed loop fixed to the first frame.

18. The system of claim 15 in combination with at least one threaded fastener, each hanger member having at least one fully encircled through-hole therein for engagement of a respective threaded fastener into a truss or rafter of the sloped roof via said fully encircled through-hole.

19. The system of claim 1 wherein at least one of the first and second frames comprises at least one hollow frame member, and at least one utility inlet and at least one utility outlet connected to said at least one hollow frame member for conveyance of a utility through a hollow interior of the at least one hollow frame member to the utility outlet from a supply line connected to the utility inlet.

20. The system of claim 19 wherein the hollow interior of the at least one hollow frame member is fluid tight, and the utility inlet comprises a hose fitting for connection of a fluid supply hose thereto.

21. The system of claim 20 wherein the hose fitting comprises a pneumatic fitting for conveyance of pressurized air through the hollow interior of the first frame.

22. The system of claim 20 wherein the hose fitting comprises a plumbing fitting.

23. The system of claim 19 wherein the utility inlet and utility outlet comprise electrical cable connectors that are connected by electric wiring routed through the hollow interior of the at least one hollow frame member.

24. A rooftop bracket comprising:
a frame having opposing top end bottom ends and opposing sides joining said top and bottom ends together; and
at least one hanger member connected to the first frame and extending upwardly relative to the top end of the first frame to a position thereabove for attachment to a sloped roof at a position upslope from the first frame so as to hang the first frame from the hanger member in a position lying atop the sloped roof;
wherein the at least one hanger member is adjustably connected to the frame for adjustable positioning of the hanger member along the top end of the first frame.

25. A rooftop bracket system comprising:
a frame arranged for attachment to a sloped roof in a position placing a rear face of the frame against said sloped roof; and
a removable member selectively connectable to the frame in a position in which a ledge of the removable member projects forwardly from the frame to extend away from the sloped roof when the frame is laid thereon in order to support a load acting downwardly against an upward facing side of the ledge.

26. A rooftop bracket comprising:
a frame arranged for attachment to a sloped roof in a position placing a rear face of the frame against said sloped roof; and
a ledge member connected to the frame and movable thereto between a storage position bound by a perimeter of the frame in a same plane as said frame, and a useful position projecting forwardly away from the frame to extend away from the sloped roof when the frame is laid thereon in order to support a load acting downwardly against an upward facing side of the ledge.

27. A rooftop bracket comprising a frame arranged for attachment to a sloped roof in a position placing a rear face of the frame against said sloped roof, wherein at least one of the first and second frames comprises at least one hollow frame member, and at least one utility inlet and at least one utility outlet connected to said at least one hollow frame member for conveyance of a utility commodity through a hollow interior of the at least one hollow frame member to the utility outlet from a supply line connected to the utility inlet.
